(19) United States
(12) Patent Application Publication
(10) Pub. No.: US 2005/0122023 A1
(43) Pub. Date: Jun. 9, 2005

(54) Shock Resistant Spark Plug

(76) Inventor: Dan B. Pool, Scottsdale, AZ (US)

Correspondence Address: Designer Products, 8180 N. Hayden Rd. Ste. D-203, Scottsdale, AZ, 85258, US

(21) Appl. No.: 10/904,891

(22) Filed: Dec. 2, 2004

Related U.S. Application Data
(60) Provisional application No. 60/527,657, filed on Dec. 8, 2003.

(51) Int. Cl. H01T 13/20; H01T 13/00

(52) U.S. Cl. 313/143

(57) ABSTRACT

An ordinary spark plug having an electrode shaft, a non conductive elastomeric boot, ceramic insulation and a metal chassis. The elastomeric boot around the electrode being heat resistant creates a protective barrier.

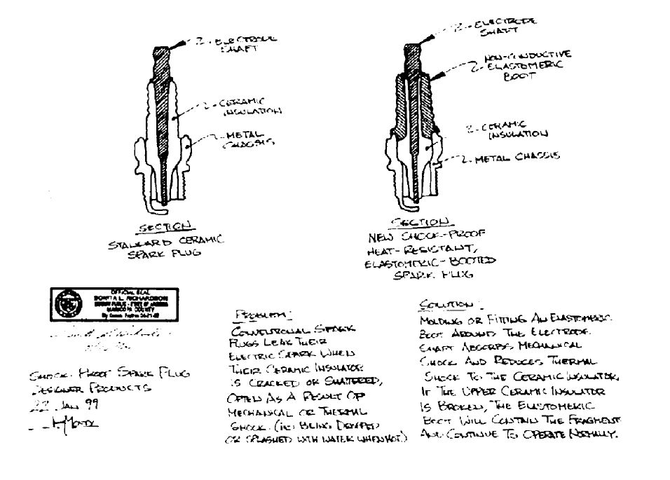

Ordinary spark plugs use a breakable ceramic to insulate the spark plug electrode core from grounding without creating an arc through its gap. One problem with this material is that it does not handle thermal or mechanical shock very well and can be easily broken by a sharp blow, cold water, or a socket wrench. Broken or cracked ceramic insulators can leak their charge to ground before creating an arc through their gap and become useless. Even worse, fragments of the hard ceramic can fall down into the cylinder and cause major damage to pistons, valves, and cylinder walls if the ceramic is accidentally broken by a socket wrench or other such tool.

Our Invention solves both of these problems by surrounding the ceramic electrode insulator with a layer of non-conductive material that can better withstand thermal and mechanical shock. Furthermore, the non-conductive material will contain fragments of ceramic if forces (such as those from a wrench) happen to break the ceramic inside.

A preferred fit of the material will completely envelope the ceramic insulator or electrode shaft from the threaded metal chassis to the plug wire connector in such a way as to prevent fragments of broken ceramic from escaping the material. One way to accomplish this is to fit or mold the material onto or over the threaded metal chassis.

1. A spark plug with a molding or fitting of a heat resistant elastomeric sleeve around the electrode shaft of the upper portion of a standard ceramic insulated spark plug.

2. A spark plug as claimed in claim 1 wherein the spark plug contains a sleeve consisting of organic non-conductive compounds, such as high temperature elastomers or high temperature injection molded polymers or organic thermosets.

3. A spark plug as claimed in claim 1 wherein the spark plug contains a sleeve consisting of inorganic non-conductive compounds, such as flexible RTV silicone, rigid silicon, or glass variations.

4. A spark plug as claimed in claim 1 wherein production methods for processing or assembling these materials would include (but not necessarily be limited to): Injection molding material directly onto the ceramic insulation.

5. A spark plug as claimed in claim 4 wherein the sparkplug would include injection molding material directly onto the electrode shaft to replace or reduce the ceramic insulation.

6. A spark plug as claimed in claim 4 wherein the sparkplug would include injection molding or extruding the material separate from the ceramic insulation or electrode shaft and fitting the materials over the ceramic insulation or electrode shaft.

7. A spark plug as claimed in claim 4 wherein the spark plug would include fitting material with mechanical means of attachment, such as crimping the threaded metal chassis over the material during production processes.

8. A spark plug as claimed in claim 4 wherein the spark plug would include fitting material with interference or friction, such as sliding the material over underlying pips or voids to create a tight fit.

9. A spark plug as claimed in claim 4 wherein the spark plug would include forming the material separately and using adhesive to attach to the ceramic insulation or electrode shaft.

10. A spark plug as claimed in claim 4 wherein the sparkplug would include Spraying the material directly onto the ceramic insulation or electrode shaft.

11. A spark plug as claimed in claim 4 wherein the sparkplug would include Wrapping the material around the ceramic insulation or electrode shaft.

12. A spark plug as claimed in claim 4 wherein the sparkplug would include Otherwise molding or forming the material directly onto the ceramic insulation or electrode shaft.
